(19) United States
(12) Patent Application Publication
(10) Pub. No.: US 2019/0235584 A1
(43) Pub. Date: Aug. 1, 2019

(54) ELECTRONIC DEVICE

(71) Applicant: Murata Manufacturing Co., Ltd., Nagaokakyo-shi (JP)

(72) Inventors: Nobuyuki TENNO, Nagaokakyo-shi (JP); Toshinori IKUNO, Nagaokakyo-shi (JP)

(21) Appl. No.: 16/377,328

(22) Filed: Apr. 8, 2019

Related U.S. Application Data
(63) Continuation of application No. PCT/JP2017/039085, filed on Oct. 30, 2017.

(30) Foreign Application Priority Data
Nov. 21, 2016 (JP) 2016-225883

(51) Int. Cl. G06F 1/16; H02J 50/10; H01Q 1/24; H02J 7/02

(52) U.S. Cl. CPC G06F 1/1683; H02J 50/10; H02J 7/025; H01Q 1/243; G06F 1/1681

(57) ABSTRACT

An electronic device includes a first main body portion including first and surfaces, and a second main body portion connected to the first main body portion. The first main body portion includes a display close to the first surface, and a first coil antenna. The second main body portion includes a second coil antenna. The first coil antenna is closer to the second surface than to the first surface. The second coil antenna is disposed in the second main body portion. The electronic device is switchable between a first state in which the second main body portion does not overlap the second surface when using the electronic device in the first system, and a second state in which the second main body portion overlaps the second surface when using the electronic device in the second system.

### CROSS REFERENCE TO RELATED APPLICATIONS

This application claims the benefit of priority to Japanese Patent Application No. 2016-225883 filed on Nov. 21, 2016 and is a Continuation Application of PCT Application No. PCT/JP2017/039085 filed on Oct. 30, 2017. The entire contents of each of these applications are hereby incorporated herein by reference.

### BACKGROUND OF THE INVENTION

### 1. Field of the Invention

The present invention relates to an electronic device, and more particularly, to an electronic device for use in a plurality of systems.

### 2. Description of the Related Art

An electronic device including a coil antenna for a short-range wireless communication (NFC: Near Field Communication) system and a coil antenna for a wireless power transmission system is known.

For example, International Publication No. 2014/167881 discloses an electronic device in which a coil antenna for NFC and a coil antenna for wireless power transmission are both provided on a first surface (back surface) side of the device. In this electronic device, the two coil antennas are spaced apart so that the two coil antennas do not interfere with each other.

However, in the configuration in which both of the two coil antennas are provided on the first surface side, if the two coil antennas are arranged so as not to interfere with each other, the position, size, shape, and other characteristics of the coil antennas are restricted, which may lower the degree of freedom of design.

In contrast, Japanese Unexamined Patent Application Publication No. 2011-123708 discloses an electronic device with a configuration in which a coil antenna for wireless power transmission is disposed on a first surface (back surface) side of the device, and a coil antenna for NFC is disposed on a second surface (front surface) side on which a display is provided.

However, because the coil antenna for NFC is disposed on the second surface (front surface) side of the electronic device disclosed in Japanese Unexamined Patent Application Publication No. 2011-123708 on which the display is provided, it may be impossible to check on the display the communication status (displaying of a communication error or the like) at the time of NFC communication. Therefore, the convenience of the electronic device at the time of NFC communication may be reduced. In addition, in the case of disposing the coil antenna for NFC on the front surface on which the display is provided, it is necessary to perform communication while bringing the display surface close to an apparatus that serves as a communication partner of NFC. Therefore, the display may be shocked or damaged at the time of NFC communication, leaving small scratches on the display, which lowers the visibility of the display. Such circumstances are not limited to the case in which a coil antenna disposed on the front surface is for an NFC system, and such circumstances similarly occur in the case in which a coil antenna disposed on the front surface is for other systems, such as power transmission. In addition, such circumstances are not limited to an electronic device including a coil antenna for NFC and a coil antenna for power transmission, and such circumstances similarly occur in the case in which an electronic device includes a plurality of coil antennas used in a plurality of respective systems.

### SUMMARY OF THE INVENTION

Preferred embodiments of the present invention provide electronic devices each including a plurality of coil antennas used in a plurality of respective systems, which enables checking of the displayed details of a display when using the electronic device in one system and which also enables communication without bringing the display close to a communication partner.

An electronic device according to a preferred embodiment of the present invention includes a first main body portion including a first surface and a second surface facing the first surface; and a second main body portion capable of covering at least a portion of the first main body portion, wherein the first main body portion includes a display disposed on the first surface side, and a first coil antenna for a first system, the first coil antenna being disposed on the second surface side, the second main body portion includes a second coil antenna for a second system, and the electronic device is switchable between a first state in which the second main body portion does not overlap the second surface when using the electronic device in the first system, and a second state in which the second main body portion overlaps the second surface when using the electronic device in the second system.

With this configuration, compared with the case in which the first coil antenna and the second coil antenna are disposed on the same surface side of the first main body portion, restrictions on the position, size, shape, and other characteristics of the first coil antenna and the second coil antenna are reduced, thus increasing the degree of freedom of design.

In addition, with this configuration, the displayed details of the display are able to be checked while using the electronic device in the second system, which also enables operations with the display.

In an electronic component according to a preferred embodiment of the present invention, the second main body portion may be a cover portion connected to the first main body portion.

In an electronic component according to a preferred embodiment of the present invention, the second main body portion may be a cover portion detachable from the first main body portion.

In an electronic component according to a preferred embodiment of the present invention, the electronic device may further include a magnetic layer in the second main body portion. It is preferable that, in the second state, the first coil antenna, the second coil antenna, and the magnetic layer overlap one another when viewed from a winding axis direction of the second coil antenna, and are arranged in an order of the first coil antenna, the magnetic layer, and the second coil antenna from the first surface side to the second surface side. With this configuration, in the second state, the magnetic-field coupling between the second coil antenna and a coil antenna of a communication partner is able to be improved by the magnetic collection effect of the magnetic layer.

In an electronic component according to a preferred embodiment of the present invention, the electronic device may further include a metal layer in the second main body portion. It is preferable that, in the second state, the first coil antenna, the second coil antenna, and the metal layer overlap one another when viewed from a winding axis direction of the second coil antenna, and are arranged in an order of the first coil antenna, the metal layer, and the second coil antenna from the first surface side to the second surface side. With this configuration, in the second state, magnetic fluxes that occur from the second coil antenna are blocked by the metal layer, and coupling between the first coil antenna and the second coil antenna, which are close to each other in the winding axis direction, is reduced or prevented.

In an electronic component according to a preferred embodiment of the present invention, the electronic device may further include a magnetic layer in the second main body portion, and a metal layer in the second main body portion. It is preferable that, in the second state, the first coil antenna, the second coil antenna, the magnetic layer, and the metal layer overlap one another when viewed from a winding axis direction of the second coil antenna, and are arranged in an order of the first coil antenna, the metal layer, the magnetic layer, and the second coil antenna from the first surface side to the second surface side. With this configuration, in the second state, because magnetic fluxes that occur from the second coil antenna are blocked by the metal layer, coupling between the first coil antenna and the second coil antenna, which are close to each other in the winding axis direction, is reduced or prevented (interference between the coil antennas is reduced or prevented). In addition, with this configuration, in the second state, the magnetic-field coupling between the second coil antenna and a coil antenna of a communication partner is able to be improved by the magnetic collection effect of the magnetic layer.

In an electronic component according to a preferred embodiment of the present invention, the electronic device may further include a power feeding coil used in the second system. It is preferable that, in the second state, the metal layer overlaps an entirety or substantially an entirety of the first coil antenna when viewed from the winding axis direction, and it is also preferable that the second coil antenna includes a portion that overlaps neither the magnetic layer nor the metal layer viewed from the winding axis direction. It is preferable that the power feeding coil is magnetic-field coupled to the second coil antenna. With this configuration, the electronic device is able to be used in the second system without directly connecting the second coil antenna and the second system circuit to each other.

In an electronic component according to a preferred embodiment of the present invention, in the first state, the second main body portion may overlap the first surface when using the electronic device in the first system.

In an electronic component according to a preferred embodiment of the present invention, it is preferable that, in the first state, the second main body portion includes a portion that does not overlap a portion of the display. With this configuration, even in a state in which the second main body portion overlaps the first surface of the first main body portion, display details displayed on the other portion of the display (a portion not covered with the cover portion) is able to be checked while using the electronic device in the first system.

In an electronic component according to a preferred embodiment of the present invention, the first system may be an electro-magnetic induction power transmission system, and the second system may be a short-range wireless communication system.

According to preferred embodiments of the present invention, in electronic devices each including a plurality of coil antennas used in a plurality of respective systems, the electronic devices which each enable checking of the displayed details of a display when using the electronic devices in one system and which also enables communication without bringing the display close to a communication partner are able to be achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is an exterior perspective view of an electronic device 301 according to a first preferred embodiment of the present invention, and FIG. 1B is an exterior perspective view of the electronic device 301 from a viewpoint different from FIG. 1A.

FIG. 2A is an exterior perspective view illustrating the electronic device 301 in a first state, and FIG. 2B is a sectional view of the electronic device 301 in the first state.

FIG. 3A is an exterior perspective view illustrating the electronic device 301 in a second state, and FIG. 3B is a sectional view of the electronic device 301 in the second state.

FIG. 4 is a circuit diagram of the electronic device 301.

FIG. 5A is an exterior perspective view of an electronic device 302 according to a second preferred embodiment of the present invention, and FIG. 5B is an external perspective view of the electronic device 302 from a viewpoint different from FIG. 5A.

FIG. 6 is a sectional view of the electronic device 302 in the first state.

FIG. 7A is a sectional view of the electronic device 302 in the second state, and FIG. 7B is a sectional view of the electronic device 302 viewed from a different direction in the second state.

FIG. 8 is a circuit diagram of the electronic device 302.

FIG. 9 is an exterior perspective view of an electronic device 303 according to a third preferred embodiment of the present invention in a first state.

FIG. 10A is an exterior perspective view illustrating an electronic device 304 in the first state, and FIG. 10B is an exploded perspective view of the electronic device 304 in the first state.

FIG. 11A is an exterior perspective view illustrating the electronic device 304 in the second state, and FIG. 11B is an exploded perspective view of the electronic device 304 in the second state.

FIG. 12A is an exterior perspective view of an electronic device 305 according to a fifth preferred embodiment of the present invention, and FIG. 12B is a plan view of the electronic device 305, illustrating a state in which a case 500 is removed from a first main body portion 102B.

FIG. 13A is an exterior perspective view of an electronic device 306 according to a sixth preferred embodiment of the present invention, and FIG. 13B is an external perspective view of the electronic device 306 from a viewpoint different from FIG. 13A.

FIG. 14A is an exterior perspective view illustrating the electronic device 306 in the first state, and FIG. 14B is a sectional view of the electronic device 306 in the first state.

FIG. 15A is an exterior perspective view illustrating the electronic device 306 in the second state, and FIG. 15B is a sectional view of the electronic device 306 in the second state.

FIG. 16 is a circuit diagram of the electronic device 306.

FIG. 17A is a back view of an electronic device 306A according to a modification of the sixth preferred embodiment of the present invention, and FIG. 17B is a back view of an electronic device 306B.

### DETAILED DESCRIPTION OF THE PREFERRED EMBODIMENTS

Hereinafter, preferred embodiments of the present invention will be described with reference to specific examples and the drawings. In the drawings, the same portions are denoted by the same reference numeral. Considering the ease of description or understanding of main points, the preferred embodiments will be described separately for the sake of convenience. However, configurations described in different preferred embodiments may be partially replaced or combined. From a second and subsequent preferred embodiments, descriptions of elements and features that are common to those of a first preferred embodiment will be omitted, and only different elements and features will be described. In particular, the same or similar operation and advantageous effects achieved by the same or similar configuration will not be described in each of the preferred embodiments.

### First Preferred Embodiment

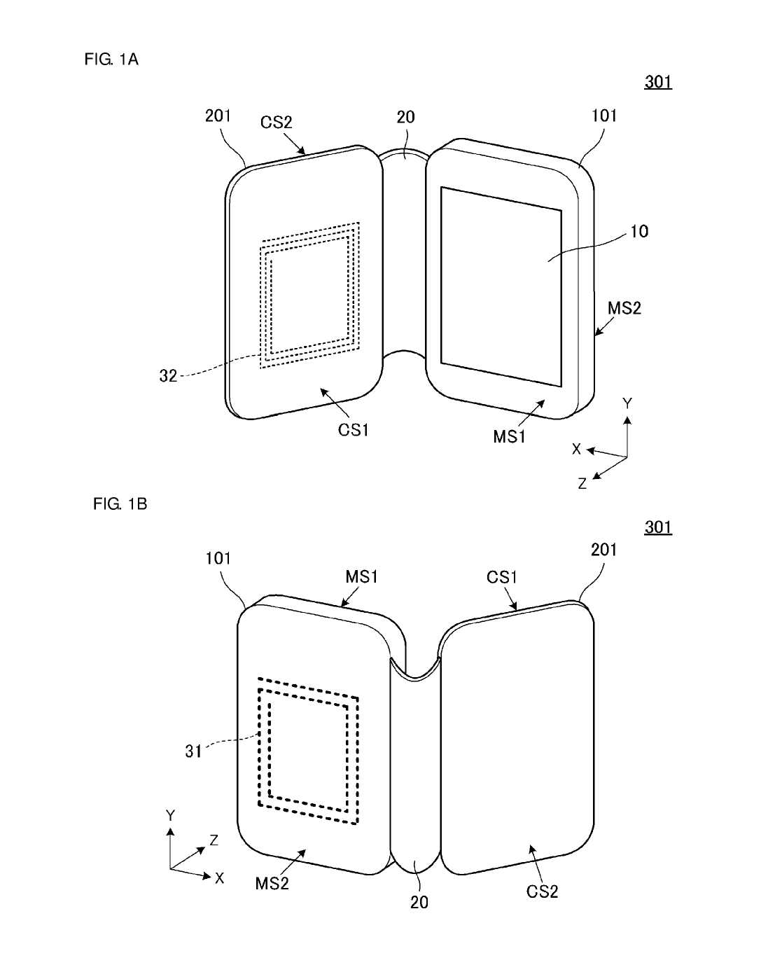

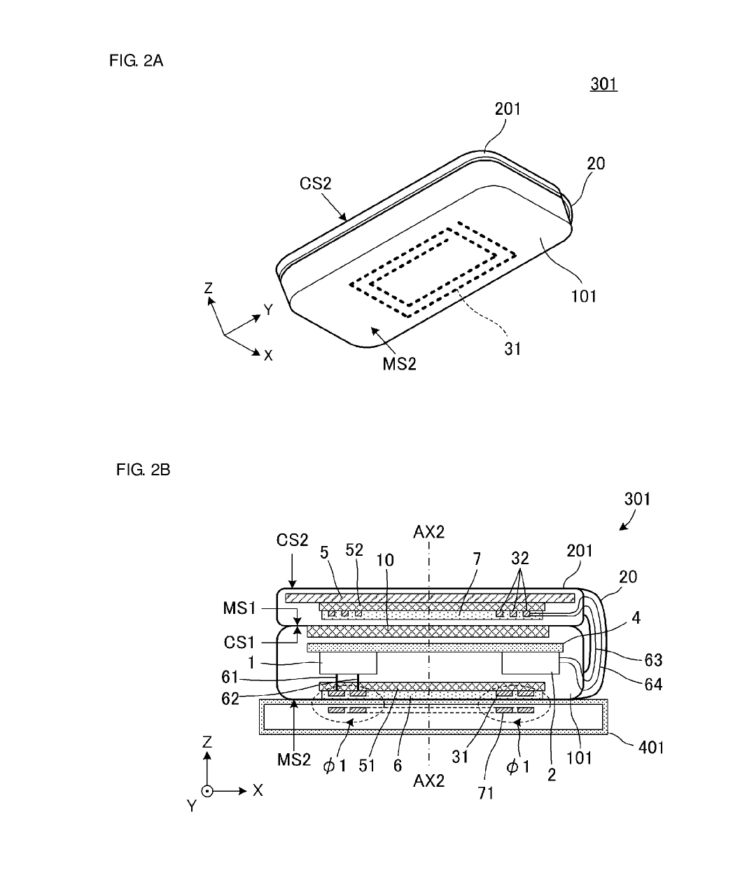

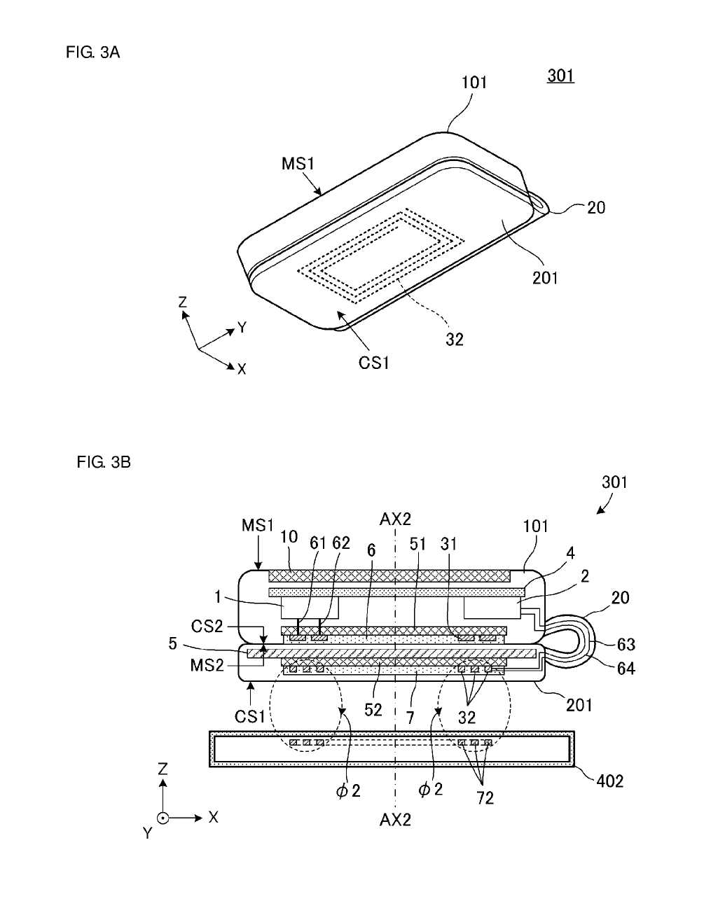

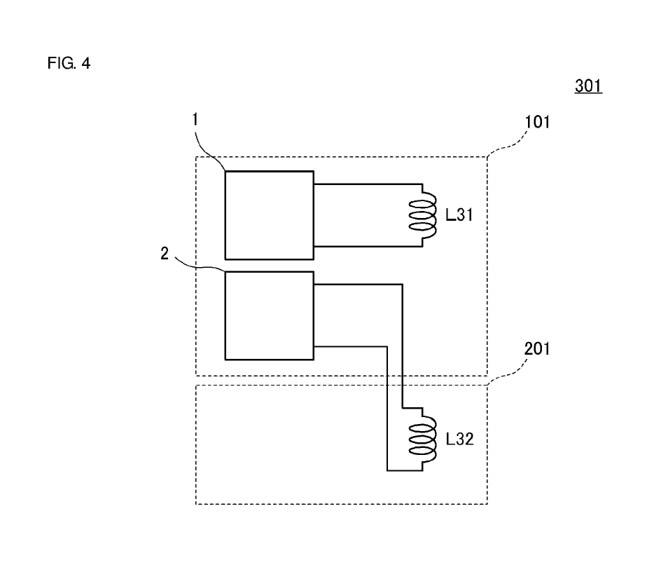

FIG. 1A is an exterior perspective view of an electronic device 301 according to a first preferred embodiment of the present invention, and FIG. 1B is an external perspective view of the electronic device 301 from a viewpoint different from FIG. 1A. FIG. 2A is an exterior perspective view illustrating the electronic device 301 in a first state, and FIG. 2B is a sectional view of the electronic device 301 in the first state. FIG. 3A is an exterior perspective view illustrating the electronic device 301 in a second state, and FIG. 3B is a sectional view of the electronic device 301 in the second state. FIG. 4 is a circuit diagram of the electronic device 301.

In FIGS. 1A, 1B, 2A, and 3A, a first coil antenna 31 and a second coil antenna 32 are illustrated by broken lines in order to clarify the structure of the electronic device 301. In FIGS. 2B and 3B, the thickness of each portion is illustrated in an exaggerated manner. The same applies to sectional views in the following preferred embodiments. In FIG. 4, the first coil antenna 31 is represented by an inductor L31, and the second coil antenna 32 is represented by an inductor L32.

The “electronic device” is an apparatus that includes a first main body portion and a second main body portion, and is, for example, a smartphone. Note that the “electronic device” may be, for example, a cellular phone terminal, a tablet terminal, a notebook PC, a PDA, a game machine, or other suitable device.

The electronic device 301 includes a first main body portion 101, a hinge portion 20, and a second main body portion 201.

The first main body portion 101 is preferably a rectangular or substantially rectangular parallelepiped that includes a first surface MS1 (front surface) and a second surface MS2 (back surface) facing the first surface MS1, and has a longitudinal direction matching the Y-axis direction. The first main body portion 101 includes a display 10, the first coil antenna 31, a first system circuit 1, a second system circuit 2, a circuit substrate 4, a magnetic layer 51, a protective layer 6, and other suitable elements. In the present preferred embodiment, the first surface MS1 and the second surface MS2 of the first main body portion 101 are orthogonal or substantially orthogonal to the Z-axis direction. The display 10 is closer to the first surface MS1 than to the second surface MS2 of the first main body portion 101. That is, the display 10 is disposed on the first surface MS1 side.

The second main body portion 201 is preferably a rectangular or substantially rectangular flat plate that includes a first surface CS1 and a second surface CS2 facing the first surface CS1, and has a longitudinal direction matching the Y-axis direction. The second main body portion 201 includes the second coil antenna 32, a magnetic layer 52, a metal layer 5, a protective layer 7, and other suitable elements. The second main body portion 201 according to the present preferred embodiment is a cover portion that is integrally connected to the first main body portion 101 with the hinge portion 20 interposed therebetween, and is capable of covering at least a portion of the first main body portion 101. The hinge portion 20 is a flexible member, and is connected to the first main body portion 101 and the second main body portion 201.

As illustrated in FIGS. 2B, 3B, and 4, the magnetic layer 51, the first coil antenna 31, the protective layer 6, the circuit substrate 4, the first system circuit 1, and the second system circuit 2 are disposed in the first main body portion 101 (specifically in the interior of a case included in the first main body portion 101).

The magnetic layer 51 is a flat magnetic member that includes two surfaces (a first surface and a second surface) extending along the first surface MS1 (or the second surface MS2) of the first main body portion 101. The first coil antenna 31 is a conductive pattern preferably in a rectangular or substantially rectangular spiral shape with about two turns, for example, provided on the first surface of the magnetic layer 51 (the bottom surface of the magnetic layer 51 in FIGS. 2B and 3B), and includes a winding axis along the Z-axis direction. The protective layer 6 is provided on the first surface of the magnetic layer 51 and covers a surface on which the first coil antenna 31 is provided. The first system circuit 1 and the second system circuit 2 are mounted on a first surface of the circuit substrate 4 (the bottom surface of the circuit substrate 4 in FIGS. 2B and 3B). The first coil antenna 31 is preferably, for example, a power receiving antenna or a power transmitting antenna used in a magnetic-field-wireless power transmission system. The circuit substrate 4 is preferably, for example, a printed wiring board, and the magnetic layer 51 is preferably, for example, a magnetic ferrite plate. The protective layer 6 is preferably, for example, a solder-resist film.

The first coil antenna 31 according to the present preferred embodiment is closer to the second surface MS2 than to the first surface MS1 (disposed on the second surface MS2 side). In addition, two ends of the first coil antenna 31 are connected to the first system circuit 1 with wiring lines 61 and 62 interposed therebetween.

The first system circuit 1 is preferably, for example, a power transmitting circuit or a power receiving circuit for a magnetic-field wireless power transmission system, such as an electro-magnetic induction power transmission system or a magnetic-field resonance power transmission system. For example, the carrier frequency band of the magnetic-field resonance power transmission system is preferably the HF band, particularly around the center frequency about 6.78 MHz. As a wireless charging standard for the magnetic-field resonance power transmission system, for example, there is the standard “Rezence (registered trademark)”, which is formulated by A4WP (Alliance for Wireless Power). In addition, the magnetic-field wireless power transmission system transmits power to a power transmission partner using magnetic-field coupling. For example, the carrier frequency band of the electro-magnetic induction power transmission system is preferably the frequency band about 110 kHz to about 205 kHz. As a wireless charging standard for the electro-magnetic induction power transmission system, for example, there is the standard “ [symbol] i (registered trademark)”, which is formulated by WPC (Wireless Power Consortium). These power transmission systems are used to, for example, charge an electronic device such as a smartphone or other suitable device. The electro-magnetic induction power transmission system is an example of a “first system”.

The second system circuit 2 is preferably, for example, a power feeding circuit for a communication system such as NFC, and is a balanced input-output HF-band IC, for example. A short-range wireless communication system is, for example, a system that uses NFC (Near field Communication). For example, the carrier frequency band of the short-range wireless communication system is preferably the HF band, particularly a frequency band around the center frequency about 13.56 MHz, for example. In addition, the short-range wireless communication system communicates with a communication partner using magnetic-field coupling. The communication system using NFC is an example of a “second system”.

In addition, as illustrated in FIGS. 2B and 3B, the magnetic layer 52, the second coil antenna 32, the protective layer 7, and the metal layer 5 are disposed in the second main body portion 201.

The magnetic layer 52 is a flat magnetic member that includes two surfaces (a first surface and a second surface) extending along the first surface CS1 (or the second surface CS2) of the second main body portion 201. The second coil antenna 32 is a conductive pattern preferably in a rectangular or substantially rectangular spiral shape with about three turns, for example, provided on the first surface of the magnetic layer 52 (the bottom surface of the magnetic layer 52 in FIGS. 2B and 3B). The second coil antenna 32 includes a winding axis AX2, which is orthogonal or substantially orthogonal to the first surface CS1 and the second surface CS2. The protective layer 7 is provided on the first surface of the magnetic layer 52 and covers a surface on which the second coil antenna 32 is provided. The metal layer 5 is preferably a plate made of metal, for example, and is disposed on the second surface of the magnetic layer 52 (the top surface of the magnetic layer 52 in FIGS. 2B and 3B). The magnetic layer 52 is preferably, for example, a magnetic ferrite plate. The protective layer 7 is preferably, for example, a solder-resist film.

In the present preferred embodiment, the second coil antenna 32 is closer to the first surface CS1 than the metal layer 5 is. In addition, two ends of the second coil antenna 32 are connected to the second system circuit 2 with wiring lines 63 and 64, a portion of which is disposed in the hinge portion 20, interposed therebetween.

The electronic device 301 is switchable between a “first state” in which the second main body portion 201 does not overlap the second surface MS2 of the first main body portion 101, and a “second state” in which the second main body portion 201 overlaps the second surface MS2 of the first main body portion 101. The “first state” is, for example, a state in which the electronic device 301 is used in the first system, and the “second state” is, for example, a state in which the electronic device 301 is used in the second system.

Note that “being used” refers to performing communication or power transmission in the first system (or the second system).

In the “first state” in the present preferred embodiment, as illustrated in FIG. 2B, the first surface CS1 of the second main body portion 201 and the first surface MS1 of the first main body portion 101 face each other, and the second main body portion 201 covers the first surface MS1 of the first main body portion 101. In other words, the “first state” in the present preferred embodiment is a state in which the second main body portion 201 overlaps the first surface MS1.

Note that the state in which the second main body portion 201 overlaps the first surface MS1 is an example of a “first state”. The “first state” is not limited only to a state in which the second main body portion 201 overlaps the first surface MS1. The “first state” need not be a state in which the second main body portion 201 overlaps the first surface MS1 as long as the second main body portion 201 does not overlap the second surface MS2. In the “first state”, in the case in which the second main body portion 201 does not overlap the first surface MS1, the displayed details of the display 10 are able to be checked while using the electronic device 301 in the first system, which also enables operations with the display 10.

In the “first state”, the first coil antenna 31 on the second surface MS2 side of the first main body portion 101 is magnetic-field coupled to a coupling partner 401 (a coil antenna 71) of the first system, which is positioned in the -Z direction of the electronic device 301 (see magnetic fluxes φ1 in FIG. 2B).

In contrast, in the “second state” in the present preferred embodiment, as illustrated in FIG. 3B, the second surface CS2 of the second main body portion 201 and the second surface MS2 of the first main body portion 101 face each other, and the second main body portion 201 covers the second surface MS2 of the first main body portion 101. In other words, the “second state” in the present preferred embodiment is a state in which the second main body portion 201 overlaps the second surface MS2. In the “second state”, the first coil antenna 31, the second coil antenna 32, the magnetic layer 52, and the metal layer 5 overlap one another when viewed from the winding axis AX2 direction (Z-axis direction) of the second coil antenna 32, and these are arranged in the order of the first coil antenna 31, the metal layer 5, the magnetic layer 52, and the second coil antenna 32 from the first surface MS1 side to the second surface MS2 side (in the -Z direction).

In the “second state”, the second coil antenna 32 in the second main body portion 201 is magnetic-field coupled to a coupling partner 402 (a coil antenna 72) of the second system, which is positioned in the -Z direction of the electronic device 301 (see magnetic fluxes φ2 in FIG. 3B).

With the electronic device 301 according to the present preferred embodiment, the following advantageous effects are achieved.

In the present preferred embodiment, the first coil antenna 31 is on the second surface MS2 side of the first main body portion 101 (disposed closer to the second surface MS2 than to the first surface MS1), and the second coil antenna 32 is on the first surface CS1 side of the second main body portion 201. In other words, the first coil antenna 31 is disposed in the first main body portion 101, and the second coil antenna 32 is disposed in the second main body portion 201. With this configuration, compared with the case in which the first coil antenna 31 and the second coil antenna 32 are disposed on the same surface side of the first main body portion, restrictions on the position, size, shape, and other configurations of the first coil antenna 31 and the second coil antenna 32 are reduced, thus increasing the degree of freedom of design.

In the electronic device 301 according to the present preferred embodiment, the display is on the first surface MS1 side of the first main body portion 101, and, in the “second state” in which the electronic device 301 is used in the second system, the second main body portion 201 overlaps the second surface MS2 of the first main body portion 101. With this configuration, as illustrated in FIG. 3B, the displayed details of the display 10 are able to be checked while using the electronic device 301 in the second system, which also enables operations with the display 10. In addition, because it is unnecessary to perform communication while bringing the display surface close to an apparatus defining and functioning as a communication partner, there will be no impact or damage that may reduce the visibility of the display.

In the electronic device 301 according to the present preferred embodiment, in the “second state”, the first coil antenna 31, the second coil antenna 32, the magnetic layer 52, and the metal layer 5 overlap one another viewed from the Z-axis direction, and are arranged in the order of the first coil antenna 31, the metal layer 5, the magnetic layer 52, and the second coil antenna 32 from the first surface MS1 side to the second surface MS2 side (in the -Z direction). With this configuration, magnetic fluxes that occur from the second coil antenna 32 are blocked by the metal layer 5 in the “second state”. Therefore, coupling between the first coil antenna 31 and the second coil antenna 32, which are close to each other in the Z-axis direction, is reduced or prevented (interference between the coil antennas is reduced or prevented). In addition, in the “second state”, the magnetic-field coupling between the second coil antenna 32 and a coil antenna of a communication partner is able to be improved by the magnetic collection effect of the magnetic layer 52.

Although the present preferred embodiment describes the example in which, in the “second state”, the metal layer 5 and the magnetic layer 52 are disposed between the first coil antenna 31 and the second coil antenna 32, the present preferred embodiment is not limited to this configuration. It is only necessary that, in the “second state”, at least one of the metal layer 5 and the magnetic layer 52 is disposed between the first coil antenna 31 and the second coil antenna 32.

Specifically, in the “second state”, the first coil antenna 31, the second coil antenna 32, and the magnetic layer 52 may overlap one another viewed from the Z-axis direction, and these may be arranged in the order of the first coil antenna 31, the magnetic layer 52, and the second coil antenna 32 from the first surface MS1 side to the second surface MS2 side (in the -Z direction). With this configuration, in the “second state”, the magnetic-field coupling between the second coil antenna 32 and a coil antenna of a communication partner is able to be improved by the magnetic collection effect of the magnetic layer 52. Alternatively, in the “second state”, the first coil antenna 31, the second coil antenna 32, and the metal layer 5 may overlap one another viewed from the Z-axis direction, and may be arranged in the order of the first coil antenna 31, the metal layer 5, and the second coil antenna 32 from the first surface MS1 side to the second surface MS2 side (in the -Z direction). With this configuration, in the “second state”, magnetic fluxes that occur from the second coil antenna 32 are blocked by the metal layer 5, and coupling between the first coil antenna 31 and the second coil antenna 32, which are close to each other in the Z-axis direction, is reduced or prevented.

### Second Preferred Embodiment

In a second preferred embodiment of the present invention, an exemplary electronic device in which the second system circuit and the second coil antenna are not directly connected to each other will be described.

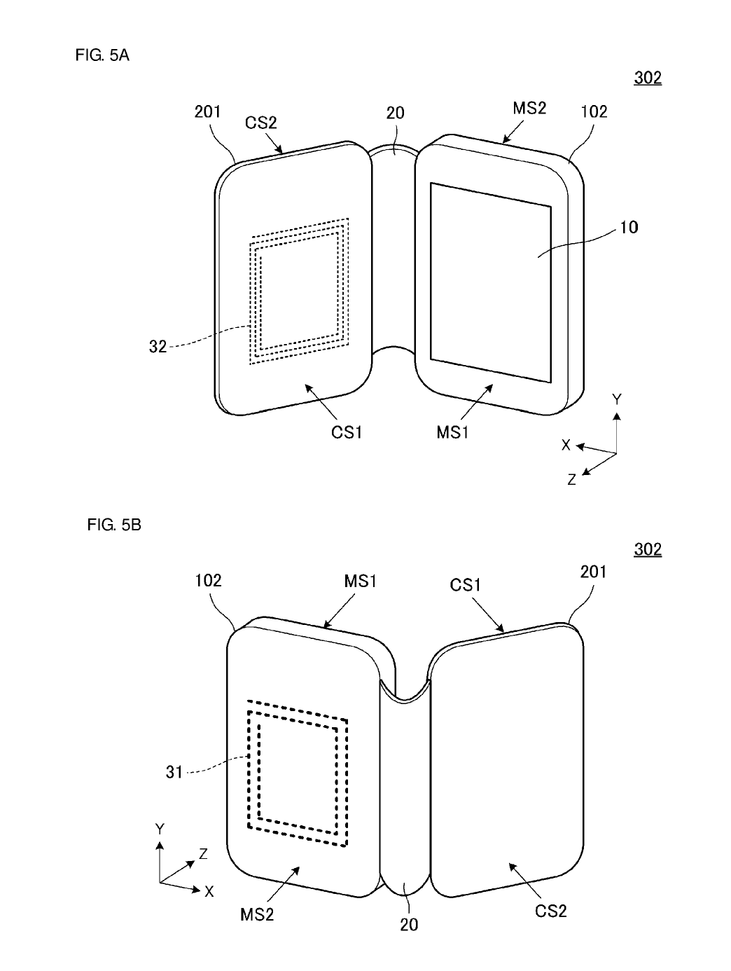

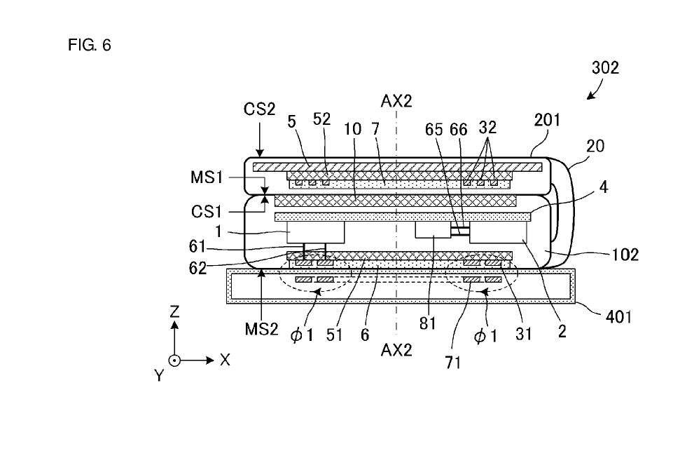

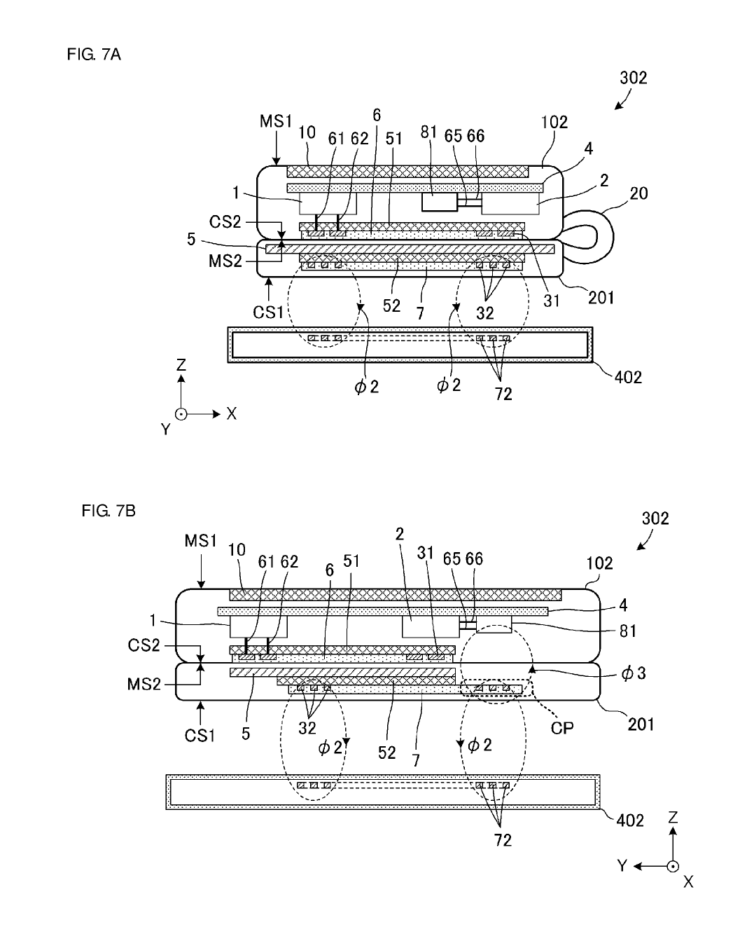

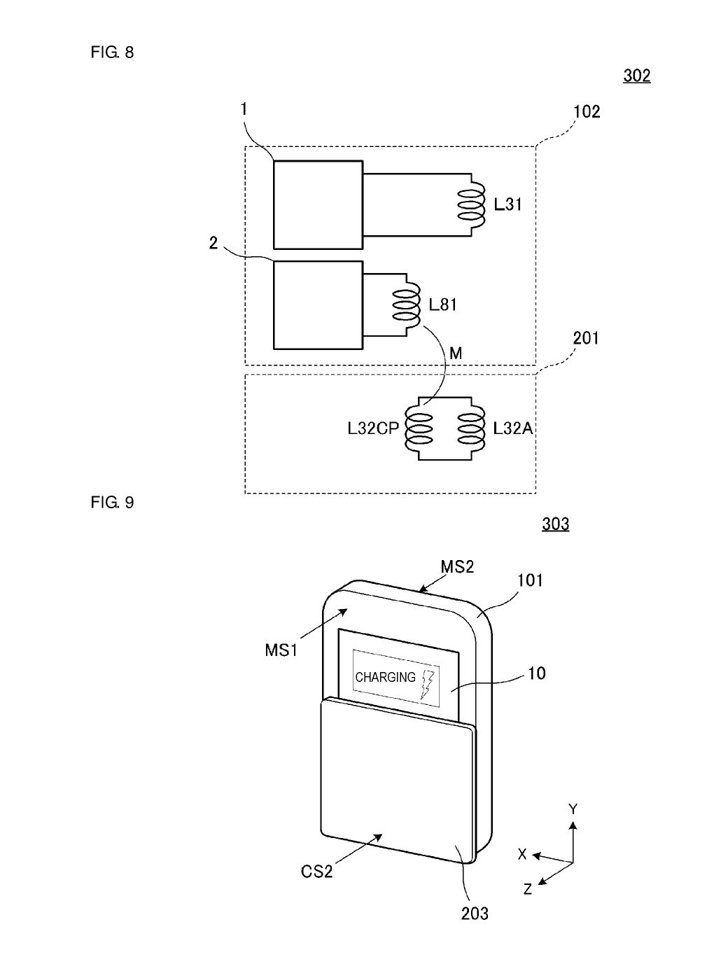

FIG. 5A is an exterior perspective view of an electronic device 302 according to the second preferred embodiment, and FIG. 5B is an external perspective view of the electronic device 302 from a viewpoint different from FIG. 5A. FIG. 6 is a sectional view of the electronic device 302 in the first state. FIG. 7A is a sectional view of the electronic device 302 in the second state, and FIG. 7B is a sectional view of the electronic device 302 viewed from a different direction in the second state. FIG. 8 is a circuit diagram of the electronic device 302.

In FIGS. 5A and 5B, the first coil antenna 31 and the second coil antenna 32 are illustrated by broken lines in order to clarify the structure of the electronic device 302. In FIG. 8, the first coil antenna 31 is represented by the inductor L31, and a power feeding coil 81 is represented by an inductor L81. In addition, in FIG. 8, the inductance of a portion of the second coil antenna 32 that is coupled to the power feeding coil 81 is represented by an inductor L32CP, and the inductance of a portion of the second coil antenna 32 that is coupled to a coil antenna of a coupling partner is represented by an inductor L32A.

The electronic device 302 is different from the electronic device 301 according to the first preferred embodiment in that the electronic device 302 includes a first main body portion 102. The first main body portion 102 is different from the first main body portion 101 according to the first preferred embodiment in that the first main body portion 102 further includes the power feeding coil 81. In addition, in the electronic device 302, the second system circuit 2 is not directly connected to the second coil antenna 32 with wiring lines interposed therebetween. The remaining configuration of the electronic device 302 is the same or substantially the same as the electronic device 301. Hereinafter, only portions that are different from the electronic device 301 will be described.

The power feeding coil 81 is disposed in the first main body portion 102 (specifically, in the interior of a case that is included in the first main body portion 102), as illustrated in FIGS. 6, 7A, and 7B. The power feeding coil 81 is a chip coil antenna used in the second system. In the present preferred embodiment, the power feeding coil 81 includes a winding axis parallel or substantially parallel to the Y-axis direction. Two ends of a coil conductor included in the power feeding coil 81 are connected to the second system circuit 2 with wiring lines 65 and interposed therebetween. The power feeding coil 81 is preferably, for example, a helical coil obtained by winding a coil conductor around a ferrite core a plurality of times.

In the present preferred embodiment, in the “second state”, the metal layer 5 overlaps the entirety or substantially the entirety of the first coil antenna 31 viewed from the Z-axis direction. Also, in the “second state”, the second coil antenna 32 includes a portion that overlaps neither the magnetic layer 52 nor the metal layer 5 (a coupling portion CP in FIG. 7B) when viewed from the Z-axis direction.

In the “second state”, the magnetic fluxes of the power feeding coil 81 and the second coil antenna 32 (particularly the coupling portion CP) are interlinked with each other, leading to magnetic-field coupling (see a magnetic flux ϕ3 in FIG. 7B). The second coil antenna 32 is magnetic-field coupled to the coupling partner 402 (the coil antenna 72) of the second system, which is positioned in the -Z direction of the electronic device 301 (see magnetic fluxes ϕ2 in FIGS. 7A and 7B).

With the electronic device 302 according to the present preferred embodiment, the following advantageous effects are achieved, in addition to the advantageous effects described in the first preferred embodiment.

In the present preferred embodiment, in the “second state”, the power feeding coil 81 connected to the second system circuit 2 and the second coil antenna 32 are magnetic-field coupled to each other. With this configuration, the electronic device is able to be used in the second system without directly connecting the second coil antenna 32 and the second system circuit 2 to each other. That is, with this configuration, the second coil antenna in the second main body portion 201 and the second system circuit 2 in the first main body portion 102 need not be connected to each other with wiring lines, disposed in the hinge portion 20, interposed therebetween. Therefore, in the electronic device 302 according to the present preferred embodiment, the second main body portion 201 need not be integrally connected to the first main body portion 102 with the hinge portion 20 interposed therebetween.

### Third Preferred Embodiment

In a third preferred embodiment of the present invention, an example in which the configuration of the second main body portion is different from the above-described preferred embodiments will be described.

FIG. 9 is an exterior perspective view of an electronic device 303 according to the third preferred embodiment in the first state.

The electronic device 303 is different from the electronic device 301 according to the first preferred embodiment in that the electronic device 303 includes a second main body portion 203. The remaining configuration of the electronic device 303 is the same or substantially the same as the electronic device 301. Hereinafter, only portions that are different from the electronic device 301 will be described.

The area of the second main body portion 203 according to the present preferred embodiment (the area of the first surface CS1 and the second surface CS2) is smaller than the area of the display 10. The second main body portion 203 includes a portion that does not overlap a portion of the display 10 (overlaps only a portion of the display 10) in a state in which the second main body portion 203 is superimposed on the first surface MS1 (first state). That is, even in a state in which the second main body portion 203 is superimposed on the first surface MS1 of the first main body portion 101 (first state), displayed details displayed on the other portion of the display 10 (a portion of the display 10 not covered with the second main body portion 203) is able to be checked while using the electronic device 303 in the first system. In the case in which the first system is an electro-magnetic induction power transmission system for charging the electronic device, as illustrated in FIG. 9, a message such as “charging” or “remaining charging time” may be displayed on the other portion of the display 10.

Although the electronic device 303 in which the second coil antenna and the second system circuit are connected to each other with wiring lines, provided in the hinge portion, interposed therebetween has been described in the present preferred embodiment, similar to the electronic device 301 according to the first preferred embodiment, the electronic device 303 is not limited to this configuration. As in the electronic device 302 according to the second preferred embodiment, the power feeding coil connected to the second system circuit and the second coil antenna may be magnetic-field coupled to each other in the “second state”.

### Fourth Preferred Embodiment

In a fourth preferred embodiment of the present invention, an exemplary electronic device in which the first main body portion and the second main body portion are not integrally connected to each other, and the second main body portion is detachable from the first main body portion will be described.

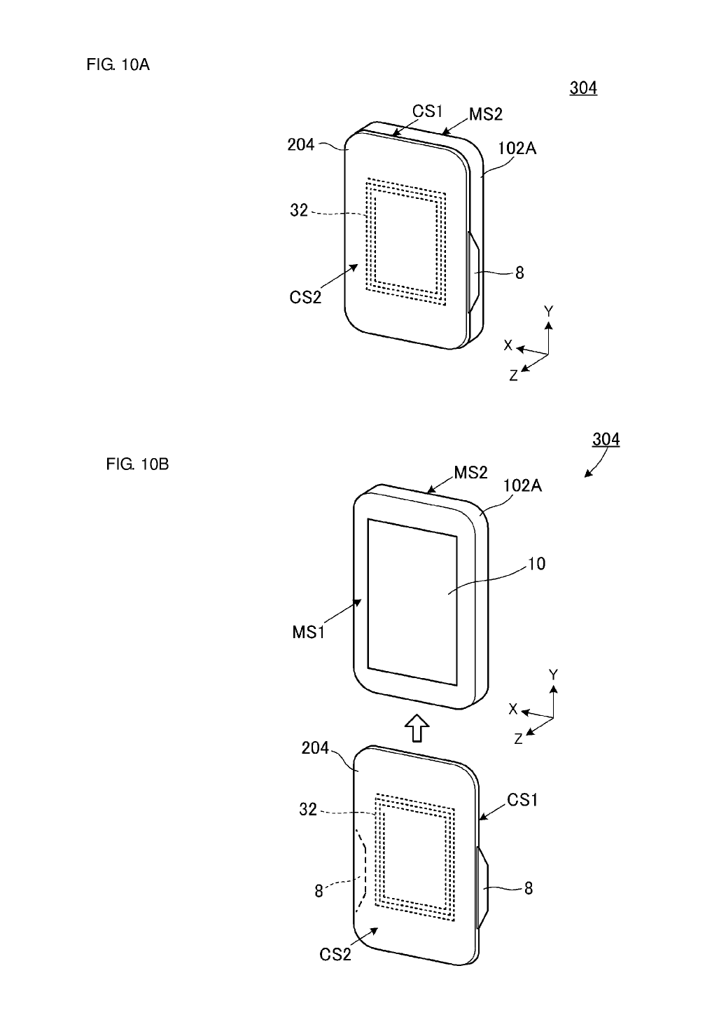

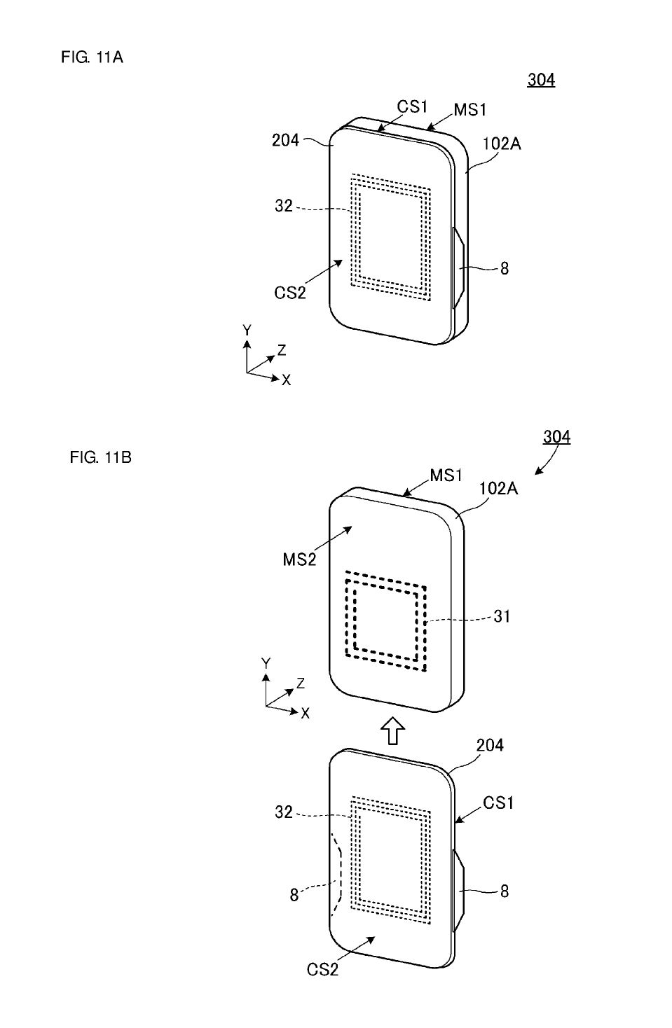

FIG. 10A is an exterior perspective view illustrating an electronic device 304 in the first state, and FIG. 10B is an exploded perspective view of the electronic device 304 in the first state. FIG. 11A is an exterior perspective view illustrating the electronic device 304 in the second state, and FIG. 11B is an exploded perspective view of the electronic device 304 in the second state. In FIGS. 10A, 10B, 11A, and 11B, the first coil antenna 31 and the second coil antenna 32 are illustrated by broken lines in order to clarify the structure of the electronic device 304.

The electronic device 304 is different from the electronic device 302 according to the second preferred embodiment in that the electronic device 304 includes no hinge portion. The remaining configuration of the electronic device 304 is the same or substantially the same as the electronic device 302.

Hereinafter, only portions that are different from the electronic device 302 will be described.

The electronic device 304 includes a first main body portion 102A, a second main body portion 204, and the second coil antenna 32. The configuration of the first main body portion 102A is the same or substantially the same as the first main body portion 102 according to the second preferred embodiment.

The second main body portion 204 is preferably, for example, a rectangular or substantially rectangular flat plate that includes the first surface CS1 and the second surface CS2 facing the first surface CS1, and has a longitudinal direction matching the Y-axis direction. The second main body portion 204 includes two cover side surface portions 8 at end portions in the transverse direction. The cover side surface portions 8 are portions extending in a direction orthogonal or substantially orthogonal to the first surface CS1 and the second surface CS2. The second main body portion 204 according to the present preferred embodiment is a cover portion that is detachable from the first main body portion 102A and that is capable of covering at least a portion of the first main body portion 102A.

In the present preferred embodiment, the first main body portion 102A includes guide grooves (not illustrated) extending in the Y-axis direction, and the cover side surface portions 8 are provided with protrusions (not illustrated). By fitting the protrusions into the guide grooves, the second main body portion 204 is attached to the first main body portion 102A.

As illustrated in FIGS. 10B and 11B, the second main body portion 204 is freely movable in the Y-axis direction by sliding the second main body portion 204 with respect to the first main body portion 102A, and is easily (freely) detachable from the first main body portion 102A.

In the “first state” according to the present preferred embodiment, as illustrated in FIGS. 10A and 10B, the first surface CS1 of the second main body portion 204 and the first surface MS1 of the first main body portion 102A face each other, and the second main body portion 204 overlaps the first surface MS1. In addition, in the “second state” according to the present preferred embodiment, as illustrated in FIGS. 11A and 11B, the first surface CS1 of the second main body portion 204 and the second surface MS2 of the first main body portion 102A face each other, and the second main body portion 204 overlaps the second surface MS2.

Even with such a configuration, the same or similar operation and advantageous effects as the electronic device 302 according to the second preferred embodiment are able to be achieved.

Note that a “detachable cover portion” does not only refer to a cover portion that is easily (freely) detachable, as described in the present preferred embodiment. The “detachable cover portion” includes a cover portion that is not easily (freely) detachable. For example, the “detachable cover portion” includes a cover portion that is not easily detachable, such as a case that covers the first main body portion for protection from external force, for example, and a case that is fixed to the first main body portion by a screw or other fastener.

Although the present preferred embodiment has described the example in which the second main body portion 204 is attached to and detached from the first main body portion 102A by sliding the second main body portion 204 with respect to the first main body portion 102A, the method of attaching the second main body portion to the first main body portion is not limited to the above-described method (sliding method). The method of attaching the second main body portion to the first main body portion may be, for example, the method of holding the first main body portion by the second main body portion (conversely, the method of holding the second main body portion by the first main body portion), the method of fixing the second main body portion to the first main body portion by fitting protrusions and grooves provided in the first main body portion and the second main body portion to each other, or other suitable methods.

Although the present preferred embodiment has described the exemplary electronic device in which, in the “second state”, the power feeding coil connected to the second system circuit and the second coil antenna are magnetic-field coupled to each other, the electronic device is not limited to this configuration. For example, the configuration may be such that an electrode connected to the second system circuit is provided on the first main body portion, an electrode connected to the second coil antenna is provided on the second main body portion, and the second main body portion is attached to the first main body portion to bring the electrodes into contact with each other, thus connecting the second coil antenna and the second system circuit to each other.

### Fifth Preferred Embodiment

In a fifth preferred embodiment of the present invention, an exemplary electronic device in which the first coil antenna and the second coil antenna are disposed in a case will be discussed.

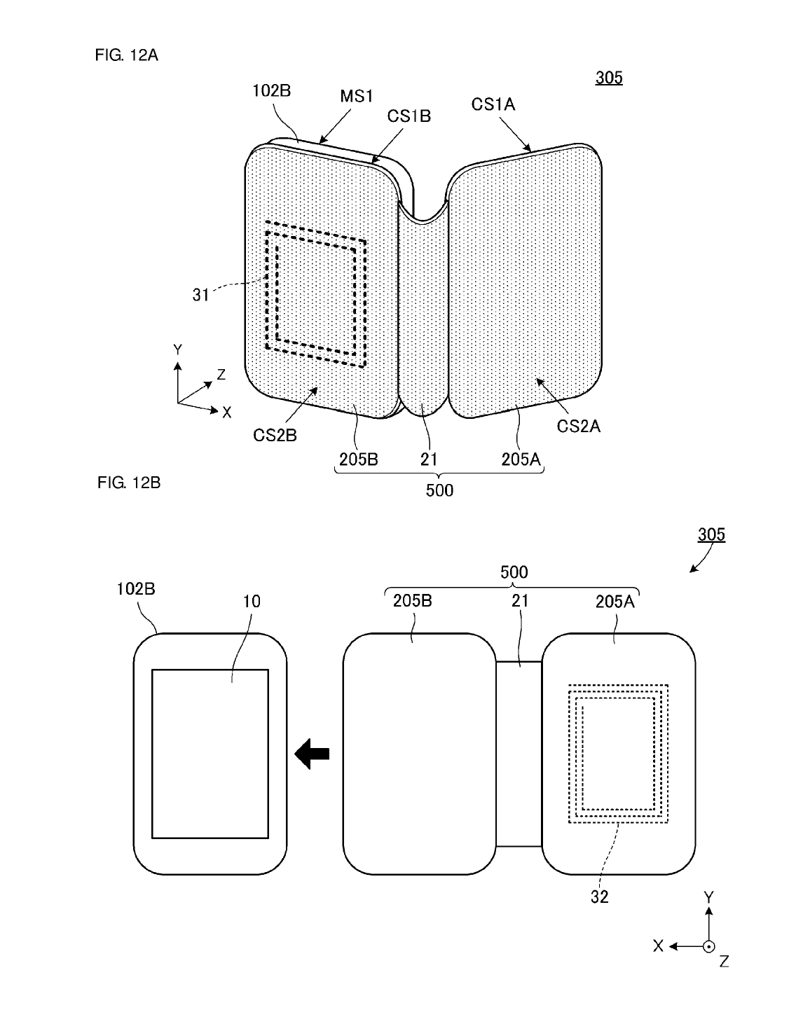

FIG. 12A is an exterior perspective view of an electronic device 305 according to the fifth preferred embodiment, and FIG. 12B is a plan view of the electronic device 305, illustrating a state in which a case 500 is removed from a first main body portion 102B. In FIGS. 12A and 12B, the first coil antenna 31 and the second coil antenna 32 are illustrated by broken lines in order to clarify the structure of the electronic device 305. In addition, the case 500 is illustrated by a dot pattern in FIG. 12A.

The electronic device 305 is different from the electronic device 304 according to the fourth preferred embodiment in that the electronic device 305 includes the case 500. The remaining configuration of the electronic device 305 is the same or substantially the same as the electronic device 304. Hereinafter, only portions that are different from the electronic device 304 will be described.

The electronic device 305 includes the first main body portion 102B and the case 500. The configuration of the first main body portion 102B is the same or substantially the same as the first main body portion 102A described in the fourth preferred embodiment.

The case 500 includes a rectangular or substantially rectangular first cover portion 205A, which includes a first surface CS1A and a second surface CS2A facing each other, a rectangular or substantially rectangular second cover portion 205B, which includes a first surface CS1B and a second surface CS2B facing each other, and a hinge portion 21. The first cover portion 205A and the second cover portion 205B preferably have the same or substantially the same planar shape, and have a longitudinal direction matching the Y-axis direction. The first cover portion 205A and the second cover portion 205B are integrally connected to each other with the hinge portion 21 interposed therebetween. The hinge portion 21 is a flexible member. The case 500 is preferably, for example, a notebook case.

In the present preferred embodiment, the first cover portion 205A corresponds to a “second main body portion”.

As illustrated in FIGS. 12A and 12B, the first coil antenna 31 is disposed in the second cover portion 205B, and the second coil antenna 32 is disposed in the first cover portion 205A (second main body portion). That is, the first coil antenna 31 and the second coil antenna 32 are not disposed in the first main body portion 102B.

As illustrated in FIG. 12A, the case 500 is attached to the first main body portion 102B such that the second surface of the first main body portion 102B and the first surface CS1B of the second cover portion 205B face each other. Therefore, the first coil antenna 31 is on the second surface side of the first main body portion 102B (disposed closer to the second surface than to the first surface MS1 of the first main body portion 102B).

By attaching the case 500 to the first main body portion 102B, the first coil antenna 31 is directly connected to the first system circuit (not illustrated) in the first main body portion 102B. In addition, the second coil antenna 32 is, in the “second state”, magnetic-field coupled to the power feeding coil (not illustrated) connected to the second system circuit (not illustrated). Note that the second system circuit and the feeding coil are disposed in the first main body portion 102B.

Even with such a configuration, the basic configuration of the electronic device 305 is the same or substantially the same as the electronic device 304 described in the fourth preferred embodiment, and the same or similar operation and advantageous effects as the electronic device 304 are able to be achieved.

Although the present preferred embodiment has described the exemplary electronic device in which the second coil antenna 32 disposed in the case 500 (the first cover portion 205A) is, in the “second state”, magnetic-field coupled to the power feeding coil (not illustrated) in the first main body portion 102B, the electronic device is not limited to this configuration. The configuration may be such that, by attaching the case 500 (the second cover portion 205B) to the first main body portion 102B, the second coil antenna 32 in the case 500 is directly connected to the second system circuit (not illustrated) in the first main body portion 102B.

### Sixth Preferred Embodiment

In a sixth preferred embodiment of the present invention, an exemplary electronic device with a configuration in which the second main body portion includes a display (dual display open/close type) will be described.

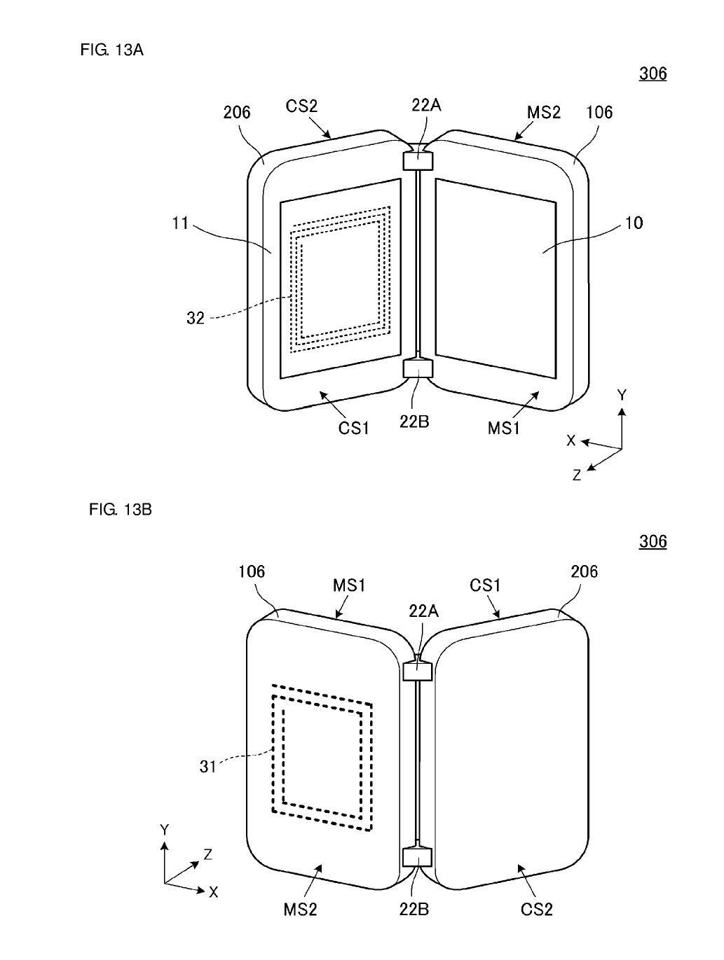

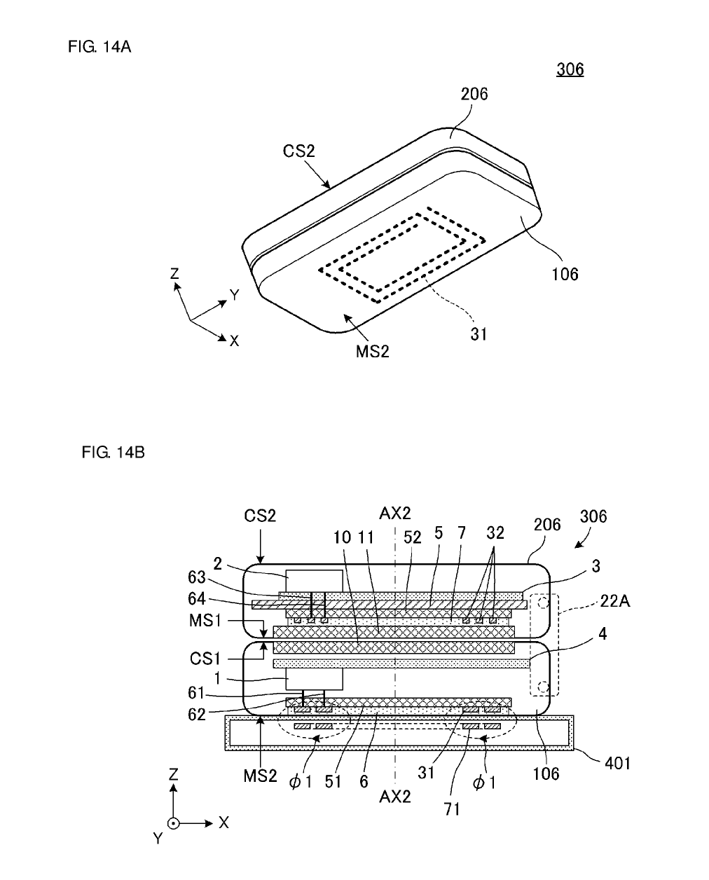

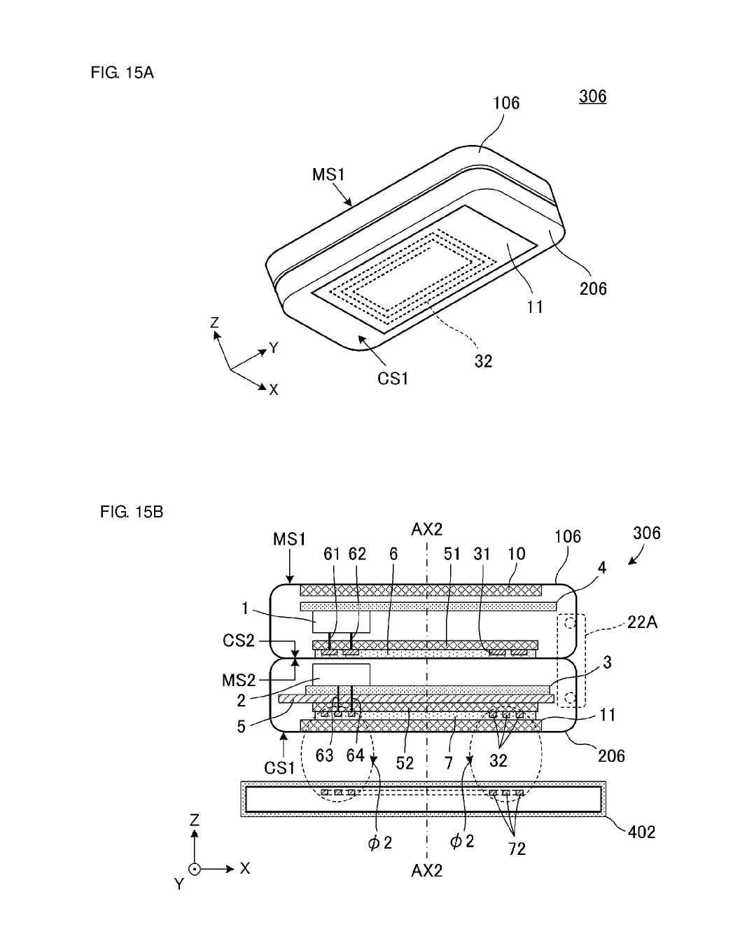

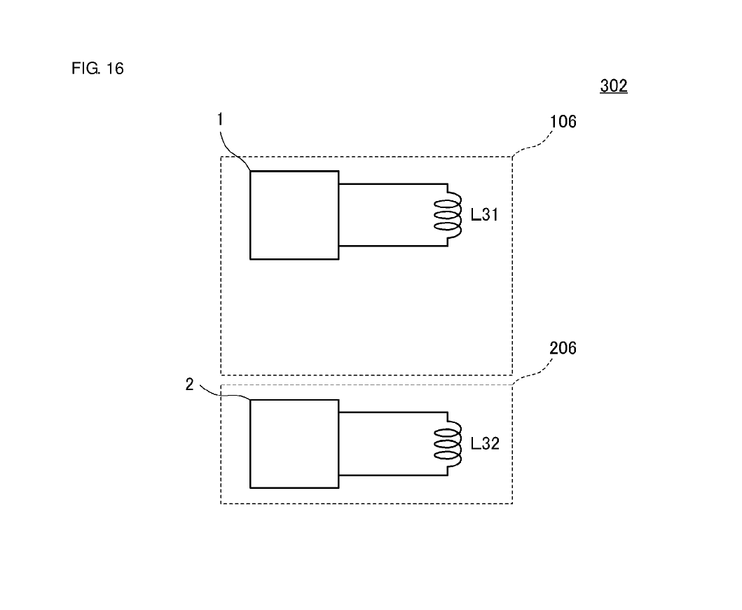

FIG. 13A is an exterior perspective view of an electronic device 306 according to the sixth preferred embodiment, and FIG. 13B is an external perspective view of the electronic device 306 from a viewpoint different from FIG. 13A. FIG. 14A is an exterior perspective view illustrating the electronic device 306 in the first state, and FIG. 14B is a sectional view of the electronic device 306 in the first state. FIG. 15A is an exterior perspective view illustrating the electronic device 306 in the second state, and FIG. 15B is a sectional view of the electronic device 306 in the second state. FIG. 16 is a circuit diagram of the electronic device 306.

In FIGS. 13A, 13B, 14A, and 15A, the first coil antenna 31 and the second coil antenna 32 are illustrated by broken lines in order to clarify the structure of the electronic device 306. In FIG. 16, the first coil antenna 31 is represented by the inductor L31, and the second coil antenna 32 is represented by the inductor L32.

The electronic device 306 is different from the electronic device 301 according to the first preferred embodiment in that the electronic device 306 includes a first main body portion 106, a second main body portion 206, and hinge portions 22A and 22B. The remaining configuration of the electronic device 306 is the same or substantially the same as the electronic device 301. Hereinafter, only portions that are different from the electronic device 301 will be described.

The first main body portion 106 is different from the first main body portion 101 described in the first preferred embodiment in that the first main body portion 106 includes no second system circuit. The second main body portion 206 is different from the second main body portion 201 described in the first preferred embodiment in that the second main body portion 206 further includes a display 11, the second system circuit 2, and a circuit substrate 3. The second main body portion 206 is connected to the first main body portion 106 with the hinge portions 22A and 22B interposed therebetween.

As illustrated in FIG. 14B, the display 11 is on the first surface CS1 side of the second main body portion 206 (disposed closer to the first surface CS1 than to the second surface CS2).

The circuit substrate 3, the second system circuit 2, and the second coil antenna 32 are disposed in the second main body portion 206 (specifically, in the interior of a case included in the second main body portion 206). The second system circuit 2 is mounted on the other surface (the top surface in FIG. 14B) of the circuit substrate 3. The circuit substrate 3 is preferably, for example, a printed wiring board.

In addition, the second coil antenna 32 is on the first surface CS1 side of the second main body portion 206 (disposed closer to the first surface CS1 than to the second surface CS2). Two ends of the second coil antenna 32 are connected to the second system circuit 2 with the wiring lines 63 and 64 interposed therebetween.

In the “first state”, the first coil antenna 31 closer to the second surface MS2 of the first main body portion 106 is magnetic-field coupled to the coupling partner 401 (the coil antenna 71) of the first system, which is positioned in the -Z direction of the electronic device 306 (see magnetic fluxes ϕ1 in FIG. 14B).

In contrast, in the “second state”, as illustrated in FIG. 15B, the second surface CS2 of the second main body portion 206 and the second surface MS2 of the first main body portion 101 face each other, and the second main body portion 206 covers the second surface MS2 of the first main body portion 106. In the present preferred embodiment, in the “second state”, the first coil antenna 31, the second coil antenna 32, the magnetic layer 52, the metal layer 5, and the display 11 overlap one another viewed from the winding axis AX2 direction (Z-axis direction) of the second coil antenna 32. In addition, in the “second state”, these are arranged in the order of the first coil antenna 31, the metal layer 5, the magnetic layer 52, the second coil antenna 32, and the display 11 from the first surface MS1 side to the second surface MS2 side (in the -Z direction).

In the “second state”, the second coil antenna 32 in the second main body portion 206 is magnetic-field coupled to the coupling partner 402 (the coil antenna 72) of the second system, which is positioned in the -Z direction of the electronic device 306, with the display 11 interposed therebetween (see magnetic fluxes ϕ2 in FIG. 15B).

As a non-limiting example of a method of magnetic-field coupling a coil antenna and a coupling partner with a display interposed therebetween, for example, the following display is used (see International Publication No. 2014/065050 and International Publication No. 2014/083990).

The above-described display includes a plurality of linear transparent electrodes (scanning electrodes) arrayed at equal intervals in the Y-axis direction, and a plurality of linear transparent electrodes (signal electrodes) that face the scanning electrodes and that are arrayed at equal intervals in the X-axis direction. Because magnetic fluxes from a coil antenna pass through the intervals between the arrayed transparent electrodes, even if a display is disposed between the second coil antenna and the coupling partner, the second coil antenna and a coil antenna of the coupling partner are able to be magnetic-field coupled to each other.

The scanning electrodes and the signal electrodes are DC-insulated from each other, and an induced current generated by the influence of the magnetic field does not flow between different electrodes (between the scanning electrodes and the signal electrodes). Therefore, the magnetic field from the second coil antenna is scarcely consumed as an induced current generated in these transparent electrodes. In addition, the transparent electrodes (scanning electrodes and signal electrodes) have higher electrical resistivity than Cu, and the transparent electrodes are thin and long in the above-described display. Therefore, almost no induced current is generated in the transparent electrodes by the influence of the magnetic field.

Note that the above-described method is only one example, and a method other than this method may be used as long as the second coil antenna and the coupling partner are magnetic-field coupled to each other with the display interposed therebetween.

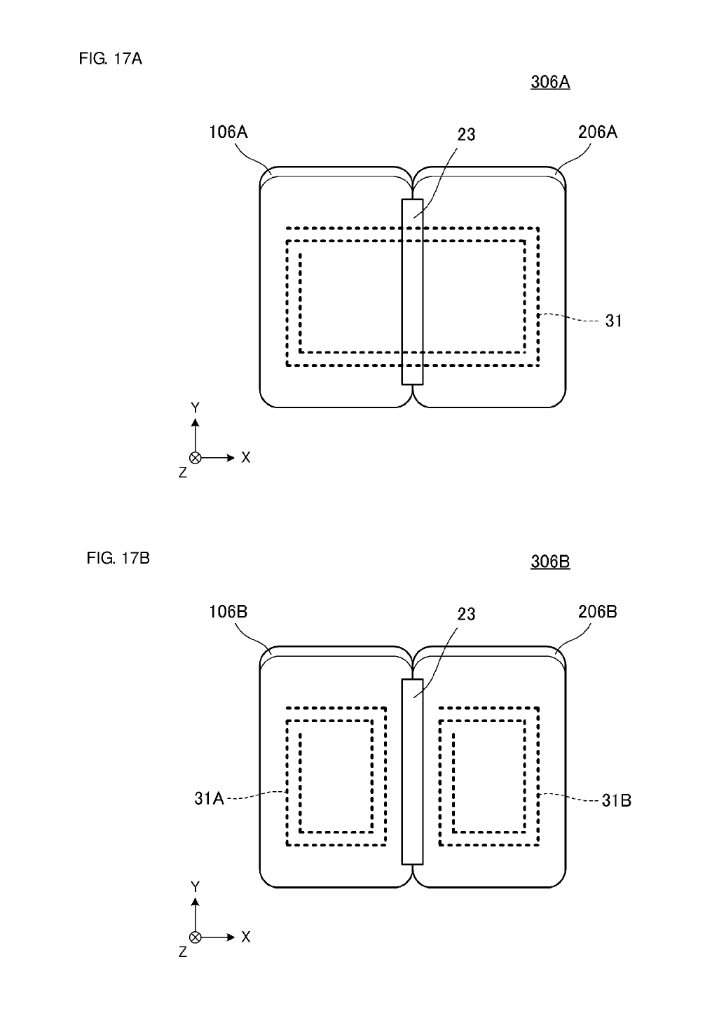

Next, a modification of the electronic device 306 described in the present preferred embodiment will be described. FIG. 17A is a back view of an electronic device 306A according to the sixth preferred embodiment, and FIG. 17B is a back view of an electronic device 306B.

The electronic device 306A illustrated in FIG. 17A is different from the above-described electronic device 306 in the configuration of the first coil antenna. The remaining configuration of the electronic device 306A is the same or substantially the same as the electronic device 306.

The electronic device 306A includes a first main body portion 106A, a second main body portion 206A, and a hinge portion 23. The first main body portion 106A and the second main body portion 206A are connected to each other with the hinge portion 23 interposed therebetween. The electronic device 306A illustrated in FIG. 17A is in the “first state” which is a state in which the second main body portion 206A does not overlap a second surface of the first main body portion 106A (the front surface of the first main body portion 106A in FIG. 17A), and which is a state in which the electronic device 306A is used in the first system.

The first coil antenna 31 of the electronic device 306A is provided over the first main body portion 106A and the second main body portion 206A. Specifically, the first coil antenna 31 is on a second surface side of the first main body portion 106A (a position closer to the front surface than to the back surface of the first main body portion 106A in FIG. 17A) and a second surface side of the second main body portion 206A (a position closer to the front surface than to the back surface of the second main body portion 206A in FIG. 17A).

The electronic device 306B illustrated in FIG. 17B is different from the above-described electronic device 306 in that the electronic device 306B includes a plurality of first coil antennas. The remaining configuration of the electronic device 306B is the same or substantially the same as the electronic device 306.

The electronic device 306B includes a first main body portion 106B, a second main body portion 206B, and the hinge portion 23. The first main body portion 106B and the second main body portion 206B are connected to each other with the hinge portion 23 interposed therebetween. The electronic device 306B illustrated in FIG. 17B is in the “first state” which is a state in which the second main body portion 206B does not overlap a second surface of the first main body portion 106B (the front surface of the first main body portion 106B in FIG. 17B), and which is a state in which the electronic device 306B is used in the first system.

The first main body portion 106B includes a first coil antenna 31A, and the second main body portion 206B includes a first coil antenna 31B. Specifically, the first coil antenna 31A is on the second surface side of the first main body portion 106B (a position closer to the front surface than to the back surface of the first main body portion 106B in FIG. 17B). The first coil antenna 31B is on the second surface side of the second main body portion 206B (a position closer to the front surface than to the back surface of the second main body portion 206B in FIG. 17B).

The first coil antennas 31A and 31B are preferably, for example, power receiving antennas or power transmitting antennas used in a magnetic-field wireless power transmission system. Similar to the electronic device 306B illustrated in FIG. 17B, the second main body portion 206B may include the first coil antenna 31B, in addition to the first coil antenna 31A included in the first main body portion 106B.

Furthermore, if the first main body portion includes a first coil antenna, the first main body portion or the second main body portion may include a coil antenna for a third system (a system other than the first system and the second system).

Although the above-described preferred embodiments have described examples in which the first main body portion is a rectangular or substantially rectangular parallelepiped, the first main body portion is not limited to this configuration. The planar shape of the first main body portion is appropriately changeable within a scope of providing the operation and advantageous effects of the present invention, and may be, for example, polygonal, circular, elliptical, L-shaped, T-shaped, or other suitable shapes. Although the first to fourth preferred embodiments have described the examples in which the second main body portion is a rectangular or substantially rectangular flat plate, the second main body portion is not limited to this configuration. The planar shape of the second main body portion is also appropriately changeable within a scope of providing the operation and advantageous effects of the present invention, and may be, for example, polygonal, circular, elliptical, L-shaped, T-shaped, or other suitable shapes.

Although the above-described preferred embodiments have described examples in which the first surface MS1 and the second surface MS2 of the first main body portion are planar (flat surface), and the first surfaces CS1, CS1A, and CS1B and the second surfaces CS2, CS2A, and CS2B of the second main body portion are planar (flat surface), these surfaces are not limited to this configuration. The first surface and the second surface of the first main body portion may partially have a curved surface, and may partially have a portion extending in a direction orthogonal or substantially orthogonal to the first surface MS1 or the second surface MS2. Similarly, the first surface and the second surface of the second main body portion may partially have a curved surface, and may partially have a portion extending in a direction orthogonal to the first surface or the second surface of the second main body portion.

Although the above-described preferred embodiments have described examples in which the first coil antenna 31 is a conductive pattern in a rectangular or substantially rectangular spiral shape with about two turns, and the second coil antenna 32 is a conductive pattern in a rectangular or substantially rectangular spiral shape with about three turns, these coil antennas 31 and 32 are not limited to this configuration. The approximate shape of the first coil antenna 31 and the second coil antenna 32 is appropriately changeable, such as circular, elliptical, polygonal, or other suitable shaped when viewed from the axis direction. In addition, the first coil antenna 31 and the second coil antenna 32 may each include a loop-shaped conductor or a helical-shaped conductor, or may each include a helical-shaped multilayer coil antenna obtained by laminating base materials on each of which a loop-shaped or spiral-shaped conductor is provided. Furthermore, the number of turns of the first coil antenna 31 and the second coil antenna 32 is appropriately changeable within a scope of providing the operation and advantageous effects of the present invention. Note that the first coil antenna 31 and the second coil antenna 32 may be winding coils. In other words, the first coil antenna 31 and the second coil antenna 32 are not limited to conductor patterns.

Although the above-described preferred embodiments have described examples in which the power feeding coil 81 is a chip antenna and has a winding axis parallel or substantially parallel to the Y-axis direction, the shape, size, direction, and arrangement relationship are not limited to this configuration. It is only necessary for the power feeding coil 81 and the second coil antenna 32 to have an arrangement relationship that enables interlinkage of magnetic fluxes and magnetic-field coupling.

Although the above-described preferred embodiments have described examples in which the metal layer 5 is a flat plate, other metal members, such as a back chassis of the display in the electronic device, ground of the circuit substrate, or a battery surface may also define and function as the metal layer 5.

Although the above-described preferred embodiments have described examples in which the first system is a power transmission system, such as an electro-magnetic induction power transmission system or a magnetic-field resonance power transmission system, and the second system is a communication system, such as a short-range wireless communication system, the first system and the second system are not limited to these systems. The first system and the second system may be systems other than a communication system and a power transmission system that are different from each other.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electronic device comprising:
a first main body portion including a first surface and a second surface facing the first surface; and
a second main body portion capable of covering at least a portion of the first main body portion; wherein
the first main body portion includes:
a display disposed on a side of the first surface; and
a first coil antenna for a first system, the first coil antenna being disposed on a side of the second surface;
the second main body portion includes a second coil antenna for a second system; and
the electronic device is switchable between a first state in which the second main body portion does not overlap the second surface when using the electronic device in the first system, and a second state in which the second main body portion overlaps the second surface when using the electronic device in the second system.

2. The electronic device according to claim 1, wherein the second main body portion is a cover portion connected to the first main body portion.

3. The electronic device according to claim 1, wherein the second main body portion is a cover portion detachable from the first main body portion.

4. The electronic device according to claim 1, further comprising:
a magnetic layer disposed in the second main body portion; wherein
in the second state, the first coil antenna, the second coil antenna, and the magnetic layer overlap one another when viewed from a winding axis direction of the second coil antenna, and are arranged in an order of the first coil antenna, the magnetic layer, and the second coil antenna from the side of the first surface to the side of second surface.

5. The electronic device according to claim 1, further comprising:
a metal layer disposed in the second main body portion; wherein
in the second state, the first coil antenna, the second coil antenna, and the metal layer overlap one another when viewed from a winding axis direction of the second coil antenna, and are arranged in an order of the first coil antenna, the metal layer, and the second coil antenna from the side of the first surface to the side of the second surface.

6. The electronic device according to claim 1, further comprising:
a magnetic layer disposed in the second main body portion; and
a metal layer disposed in the second main body portion; wherein
in the second state, the first coil antenna, the second coil antenna, the magnetic layer, and the metal layer overlap one another when viewed from a winding axis direction of the second coil antenna, and are arranged in an order of the first coil antenna, the metal layer, the magnetic layer, and the second coil antenna from the side of the first surface to the side of the second surface.

7. The electronic device according to claim 6, further comprising:
a power feeding coil used in the second system; wherein
in the second state, the metal layer overlaps an entirety or substantially an entirety of the first coil antenna when viewed from the winding axis direction of the second coil antenna, and the second coil antenna includes a portion that overlaps neither the magnetic layer nor the metal layer viewed from the winding axis direction of the second coil antenna; and
the power feeding coil is magnetic-field coupled to the second coil antenna.

8. The electronic device according to claim 1, wherein, in the first state, the second main body portion overlaps the first surface when using the electronic device in the first system.

9. The electronic device according to claim 8, wherein, in the first state, the second main body portion includes a portion that does not overlap a portion of the display.

10. The electronic device according to claim 1, wherein the first system is an electro-magnetic induction power transmission system, and the second system is a short-range wireless communication system.

11. The electronic device according to claim 1, further comprising a hinge portion disposed between and connecting the first main body portion to the second main body portion.

12. The electronic device according to claim 11, wherein the hinge portion is defined by a flexible member.

13. The electronic device according to claim 1, wherein the first coil antenna is defined by a conductive pattern having a rectangular or substantially rectangular spiral shape including about two turns.

14. The electronic device according to claim 1, wherein the second coil antenna is defined by a conductive pattern having a rectangular or substantially rectangular spiral shape including about three turns.

15. The electronic device according to claim 1, wherein the first main body portion includes a first system circuit for the first system, and a second system circuit for the second system.

16. The electronic device according to claim 15, wherein the first system circuit is a power transmitting circuit or a power receiving circuit of a magnetic-field wireless power transmission system defining the first system.

17. The electronic device according to claim 16, wherein the magnetic-field wireless power transmission system is a magnetic-field resonance power transmission system.

18. The electronic device according to claim 17, wherein a carrier frequency of the magnetic-field resonance power transmission system is an HF band around a center frequency of about 6.78 MHz.

19. The electronic device according to claim 16, wherein the magnetic-field wireless power transmission system is an electro-magnetic induction power transmission system.

20. The electronic device according to claim 19, wherein a carrier frequency of the magnetic-field induction power transmission system is an HF band around a center frequency of about 13.56 MHz.
